(19) United States
(12) Patent Application Publication
(10) Pub. No.: US 2025/0078720 A1
(43) Pub. Date: Mar. 6, 2025

(54) DISPLAY DRIVING DEVICE

(71) Applicant: SAMSUNG ELECTRONICS CO., LTD., Suwon-si (KR)

(72) Inventors: SEUNGHEE KUK, Suwon-si (KR); Sewan Lee, Suwon-si (KR); Jeong Cho, Suwon-si (KR)

(73) Assignee: SAMSUNG ELECTRONICS CO., LTD., Suwon-si (KR)

(21) Appl. No.: 18/819,425

(22) Filed: Aug. 29, 2024

(30) Foreign Application Priority Data
Aug. 29, 2023 (KR) 10-2023-0113866
Dec. 11, 2023 (KR) 10-2023-0178815

(51) Int. Cl. G09G 3/20

(52) U.S. Cl. CPC G09G 3/2092; G09G 2300/0452; G09G 2310/0275; G09G 2310/0291; G09G 2310/08

(57) ABSTRACT

A display driving device includes first source amplifiers that generate a first channel signal corresponding to a first color pixel and a second channel signal corresponding to a second color pixel, second source amplifiers that generate a third channel signal corresponding to a third color pixel, first output pads that output the first channel signal and the second channel signal, second output pads that output the third channel signal, first channel lines connected between the first output pads and the first source amplifiers, and second channel lines connected between the second output pads and the second source amplifiers. Two first channel lines among the first channel lines are connected to each other, and two second channel lines among the second channel lines are connected to each other.

### CROSS-REFERENCE TO RELATED APPLICATION

This application is based on and claims priority to Korean Patent Application No. 10-2023-0113866 filed in the Korean Intellectual Property Office on Aug. 29, 2023, and Korean Patent Application No. 10-2023-0178815 filed in the Korean Intellectual Property Office on Dec. 11, 2023, the entire contents of which are incorporated herein by reference.

### BACKGROUND

### 1. Field

Aspects of the disclosure relate to a display driving device.

### 2. Description of the Related Art

With the development of information and communication technology, information related to various types of images is being distributed. Accordingly, electronic devices such as smartphones, and artificial reality systems include display devices for delivering image information to users.

As the amount of data processed to provide image information increases, high-performance display devices are required.

Meanwhile, a display device may generate and emit light using various elements. In order to improve the quality of images displayed by such display devices, a display driver integrated circuit (DDI) for displaying images on a display panel may perform various operations.

### SUMMARY

One or more aspects of the provide a switching circuit connected to a source line and a display driving device including the switching circuit.

According to an aspect of the disclosure, there is provided a display driving device, including: a plurality of first source amplifiers configured to generate a first channel signal corresponding to a first pixel of a first color and a second channel signal corresponding to a second pixel of a second color; a plurality of second source amplifiers configured to generate a third channel signal corresponding to a third pixel of a third color; a plurality of first output pads configured to output the first channel signal and the second channel signal; a plurality of second output pads configured to output the third channel signal; a plurality of first channel lines connected between the plurality of first output pads and the plurality of first source amplifiers; and a plurality of second channel lines connected between the plurality of second output pads and the plurality of second source amplifiers, wherein a first first channel line and a second first channel line among the plurality of first channel lines are connected to each other, and a first second channel line and a second second channel line among the plurality of second channel lines are connected to each other.

According to another aspect of the disclosure, there is provided a display device, including: a pixel array including: a plurality of first pixels of a first color, a plurality of second pixels of a second color, and a plurality of third pixels of a third color, the plurality of first pixels of the first color and the plurality of third pixels of the third color are repeatedly provided on odd-numbered pixel rows and connected to one of a plurality of first source lines, and the plurality of second pixels of the second color and the plurality of third pixels of the third color are repeatedly provided on even-numbered pixel rows and connected to one of a plurality of second source lines; and a switching circuit including: a first connection switch provided between a plurality of first channel lines connected to corresponding first source line among the plurality of first source lines, a second connection switch provided between a plurality of second channel lines connected to corresponding second source line among the plurality of second source lines, a third connection switch between two first channel lines among the plurality of first channel lines, and a fourth connection switch between two second channel lines among the plurality of second channel lines.

According to another aspect of the disclosure, there is provided a display device, including: a pixel array including a plurality of first pixels of a first color, a plurality of second pixels of a second color, and a plurality of third pixels of a third color, the plurality of first pixels of the first color and the plurality of third pixels of the third color repeatedly provided in odd-numbered pixel rows, and the plurality of second pixels of the second color and the plurality of third pixels of the third color repeatedly provided in even-numbered pixel rows; a plurality of first source amplifiers connected to each of a plurality of first source lines to drive the plurality of first pixels and the plurality of second pixels; and a plurality of second source amplifiers connected to each of a plurality of second source lines to drive the plurality of third pixels, wherein each of the plurality of first source lines and each of the plurality of second source lines are alternately provided, and two adjacent second source lines among the plurality of second source lines are connected to a corresponding second source amplifier among the plurality of second source amplifiers.

### BRIEF DESCRIPTION OF DRAWINGS

The above and other aspects, features, and advantages of the disclosure will be more clearly understood from the following detailed description, taken in conjunction with the accompanying drawings, in which:

FIG. 1 is a block diagram showing a display device according to an embodiment.

FIG. 2 is a block diagram showing a display device according to an embodiment.

FIG. 3 is a block diagram of a source driver and switching circuit according to an embodiment.

FIG. 4 is a diagram showing parts of a display device according to an embodiment.

FIG. 5 is a diagram showing parts of a display device according to an embodiment.

FIG. 6 is a timing diagram showing the operation of the switching circuit according to FIG. 5.

FIG. 7 is a diagram showing parts of a display device according to an embodiment.

FIG. 8 is a diagram showing parts of a display device according to an embodiment.

FIG. 9 is a timing diagram showing the operation of the display device according to FIG. 8.

FIG. 10 is a diagram showing parts of a display device according to an embodiment.

FIG. 11 is a diagram showing a display system according to an embodiment.

### DETAILED DESCRIPTION

In the following detailed description, only certain exemplary embodiments of the inventive concept have been shown and described, simply by way of illustration. As those skilled in the art would realize, the described embodiments may be modified in various different ways, all without departing from the spirit or scope of the inventive concept.

Accordingly, the drawings and description are to be regarded as illustrative in nature and not restrictive. Like reference numerals designate like elements throughout the specification. In the flowchart described with reference to drawings in this description, the operation order may be changed, several operations may be merged, certain operations may be divided, and specific operations may not be performed.

In the description, expressions described in the singular in this specification may be interpreted as the singular or plural unless an explicit expression such as “one” or “single” is used. Although terms of “first,” “second,” and the like are used to explain various constituent elements, the constituent elements are not limited to such terms. These terms are only used to distinguish one constituent element from another constituent element.

The features described herein may be implemented in different forms and should not be construed as being limited to examples described herein. Rather, the examples described herein have been provided to illustrate only some of many feasible ways of realizing the methods, devices, and/or systems described herein, many feasible ways will be clear upon an understanding of the disclosure of the present application.

The terms used herein are used only to describe various examples and will not be used to limit the disclosure. Unless the context clearly indicates otherwise, the singular form is also intended to include the plural form. The terms “comprising,” “including,” and “having” indicate the presence of recited features, quantities, operations, components, elements, and/or combinations thereof, but do not preclude the presence or addition of one or more other features, quantities, operations, components, elements, and/or combinations thereof.

Unless otherwise defined, all terms used herein, including technical and scientific terms, have the same meanings as those commonly understood by those of ordinary skill in the art to which the disclosure pertains after understanding the disclosure. Unless expressly so defined herein, terms (e.g., terms defined in a general-purpose dictionary) should be interpreted as having a meaning consistent with their meaning in the context of the relevant field and the disclosure, and should not be interpreted ideally or in an overly formalistic manner.

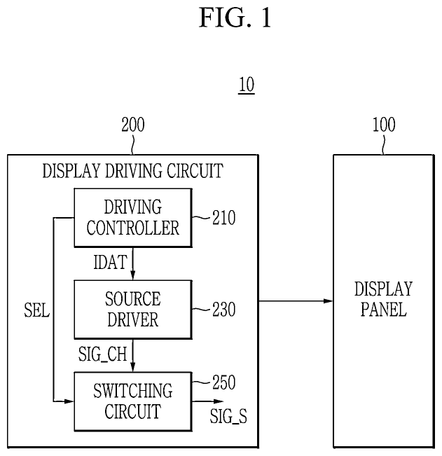

FIG. 1 is a block diagram showing a display device according to an embodiment.

Referring to FIG. 1, a display device 10 may include a display driving circuit 200 and a display panel 100 according to an embodiment. However, the disclosure is not limited thereto, and as such, according to an embodiment, the display device 10 may include other electronic components and/or electronic elements.

The display device 10 may be an electronic device with an image display function. For example, electronic devices may include, but is not limited to, smartphones, tablet personal computers (PC), portable multimedia players (PMP), cameras, wearable devices, televisions, digital video disk (DVD) players, refrigerators, air conditioners, air purifiers, set-top boxes, robots, drones, various medical devices, navigation devices, global positioning system (GPS) receivers, vehicle devices, furniture, and various measuring devices.

The display device 10 may display a two-dimensional or three-dimensional image to viewed by a user. In some embodiments, the display device 10 may be a device in which the display driving circuit 200 and the display panel 100 are implemented as a single module. For example, the display driving circuit 200 may be mounted on a substrate of the display panel 100. In another example, the display driving circuit 200 and the display panel 100 may be electrically connected through connection members, such as a flexible printed circuit board (FPCB), etc. However, the disclosure is not limited thereto, and as such, according to another embodiment, the display driving circuit 200 and the display panel 100 are implemented as separate modules.

The display panel 100 may include a plurality of pixels. The display panel 100 may receive an electrically transmitted video signal to display a two-dimensional image. For example, the display panel may include, but is not limited to, a thin film transistor-liquid crystal display (TFT-LCD), organic light emitting diode (OLED) display, field emission display, plasma display panel (PDP), or the like. In some embodiments, the display device 10 may be one or more display panels 100. For example, two display panels 100 may provide images corresponding to each eye of the user. For example, the display device 10 may include a first display panel 100 that provides images corresponding to a right eye of the user and a second display panel 100 that provides images corresponding to a left eye of the user. However, the disclosure is not limited thereto, and as such, according to an embodiment, the display device 10 may include more than two display panels.

In some embodiments, each of the plurality of pixels of the display panel 100 may be connected to a source line.

The display driving circuit 200 may generate a plurality of signals for driving the display panel 100. For example, the display driving circuit 200 may generate a plurality of analog signals. For example, the plurality of analog signals may include gate signals and source signals that drive the plurality of pixels included in the display panel 100. The display driving circuit 200 may provide gate signals and source signals to a plurality of pixels. The display panel 100 may emit light corresponding to an image according to a signal provided by the display driving circuit 200.

The display driving circuit 200 may include a driving controller 210, a source driver 230 and a switching circuit 250. However, the disclosure is not limited thereto, and as such, according to an embodiment, the display driving circuit 200 may include other electronic components and/or electronic elements.

The driving controller 210 may generate image data IDAT to display an image on the display panel 100. The driving controller 210 may provide the image data IDAT to the source driver 230. In some embodiments, the driving controller 210 may generate a selection signal SEL to control the switching circuit 250.

The source driver 230 may convert the image data IDAT into a channel signal SIG_CH based on the control of the driving controller 210. In some embodiments, the channel signal SIG_CH may be an analog signal. The source driver 230 may be connected to a plurality of channels. The source driver 230 may transmit the channel signal SIG_CH to the switching circuit 250 through a plurality of channels. The source driver 230 may drive a plurality of channels in a time-division manner during one horizontal period. The source driver 230 may provide image data for one horizontal line to a plurality of channel lines during one horizontal period. The plurality of channel lines may be activated during one horizontal period.

The switching circuit 250 may receive the selection signal SEL from the driving controller 210, and the channel signal SIG_CH from the source driver 230. The switching circuit 250 may include a plurality of switches. The switching circuit 250 may selectively drive a plurality of switches based on the selection signal SEL. The switching circuit 250 may select some of the channel signals SIG_CH based on the selection signal SEL. The switching circuit 250 may output the selected channel signal SIG_CH as a source signal SIG_S to the display panel 100. For example, The switching circuit 250 may select one or more of the channel signals SIG_CH based on the selection signal SE and output the selected one or more channel signal SIG_CH as the source signal SIG_S.

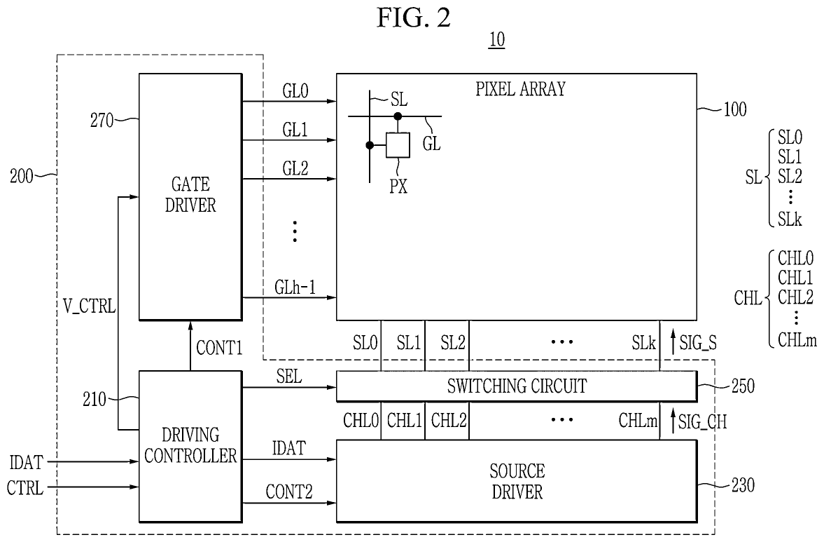

FIG. 2 is a block diagram showing a display device according to an embodiment.

Referring to FIG. 2, the display device 10 may include a pixel array 100 including a plurality of pixels PX and the display driving circuit 200.

The pixel array 100 may include a plurality of gate lines GL, a plurality of source lines SL, and the plurality of pixels PX. For example, the plurality of source lines SL extend in a first direction, and the plurality of gate lines GL extend in the second direction intersecting the first direction. The plurality of pixels PX may be arranged in a region where the plurality of gate lines GL and the plurality of source lines SL intersect. The plurality of gate lines may include gate lines GL0-GLh-1, where h is a natural number. The plurality of source lines may include source lines SL0-SLk-1, where k is a natural number.

In an example case in which the display device 10 is a thin film transistor (TFT) liquid crystal display, each pixel PX may include a TFT, a liquid crystal capacitor, and a storage capacitor. The TFT may include a gate electrode connected to the gate line, a source electrode connected to the source line, and a drain electrode connected to the liquid crystal capacitor. In an example case in which a specific gate line is selected among the plurality of gate lines GL, the TFTs of the pixels PX connected to the selected gate line may be turned on, and then data voltages may be applied to each of the plurality of source lines SL by the source driver 230. The data voltage is applied to the liquid crystal capacitor and the storage capacitor through the TFT of the corresponding pixel PX, and the liquid crystal capacitor and the storage capacitor may be driven to display an image.

Referring to FIG. 2, the pixel PX is shown as being connected to one source line SL and one gate line GL according to an embodiment. However, the connection structure of the signal line of the pixel PX of the display device is not limited thereto. As such, according to another embodiment, various signal lines may be additionally connected in accordance with the circuit structure of the pixel PX.

The display driving circuit 200 may convert an input image signal into a plurality of analog signals. For example, the display driving circuit 200 may receive a plurality of data voltages for driving the pixel array 100 from outside the display driving circuit 200, and provide a plurality of converted analog signals to the pixel array 100.

The display driving circuit 200 may include a driving controller 210, a source driver 230, a switching circuit 250, and a gate driver 270. The driving controller 210, the source driver 230, and the switching circuit 250 in FIG. 2 may be similar to the driving controller 210, the source driver 230, and the switching circuit 250 illustrated in FIG. 1.

The driving controller 210 may control the overall operation of the display driving circuit 200. For example, the driving controller 210 may divide the input image signal into one frame unit based on a vertical synchronization signal, and divide the input image signal into units of a plurality of gate lines GL based on a horizontal synchronization signal to generate image data IDAT.

In some embodiments, the driving controller 210 may receive input image signal IDAT, generate output image data IDAT having a format converted to meet the interface specifications with the source driver 230, and output image data IDAT to the source driver 230.

In some embodiments, the driving controller 210 may include a gamma voltage generator that generates a plurality of gray voltages (also referred to as gamma voltages).

In some embodiments, the driving controller 210 may control the operation timing of the display driving circuit 200. The driving controller 210 may control the operation timing of the source driver 230, the gate driver 270, and the switching circuit 250 so that the input image signal is displayed on the pixel array 100. For example, the driving controller 210 may generate various control signals for controlling a timing of the source driver 230, the switching circuit 250, and/or and the gate driver 270. For example, the driving controller 210 may generate a first control signal CONT1 corresponding to the gate driver 270, a second control signal CONT2 corresponding to the source driver 230 and a selection signal SEL corresponding to the switching circuit 250. The driving controller 210 may output a first control signal CONT1 to the gate driver 270, output a second control signal CONT2 to the source driver 230, and output the selection signal SEL to the switching circuit 250. The first control signal CONT1 may include a control signal that controls the gate level of the plurality of pixels PX. Moreover, the second control signal CONT2 may include an amplifier control signal within the source driver 230. The selection signal SEL may be a signal for driving a switch in the switching circuit 250. The selection signal SEL may be a signal that controls whether or not the switch in the switching circuit 250 is turned on.

The source driver 230 is connected to k+1 source lines SL0 to SLk, and may output source signals for driving the pixel array 100 through the k+1 source lines. The source driver 230 may implement one frame by outputting source signals for each of m+1 channel lines CHL0 to CHLm, where is a natural number.

The source driver 230 may receive data IDAT in the form of a digital signal from the driving controller 210. For example, the image data IDAT may be data corresponding to the plurality of pixels PX included in one horizontal line of the pixel array 100. In some embodiments, the image data IDAT may include gray information corresponding to each pixel PX for displaying the input image signal on the pixel array 100. In some embodiments, the source driver 230 may receive a plurality of gray voltages from the driving controller 210. The source driver 230 may convert the image data IDAT received from the driving controller 210 into the channel signal SIG_CH in the form of an analog signal based on a plurality of gray voltages.

The source driver 230 may output the channel signal SIG_CH to the switching circuit 250 in horizontal line units through a plurality of channel lines CHL. For example, the source driver 230 may transmit the channel signal SIG_CH to the switching circuit 250 according to the source driver control signal CONT2 provided from the driving controller 210. The source driver 230 may also be referred to as a data driver and source lines may also be referred to as data lines.

The switching circuit 250 may be connected to the source driver 230 through the plurality of channel lines CHL. For example, the switching circuit 250 may include a plurality of switches connected to each of the plurality of channel lines CHL. In some embodiments, the switching circuit 250 may include a switch connected between a first channel line of the plurality of channel lines CHL and a second channel line, which is adjacent to the first channel line or spaced apart from the first channel line.

The switching circuit 250 may control the operation of a plurality of switches according to the selection signal SEL provided from the driving controller 210. The switching circuit 250 may be connected to the pixel array 100 through the plurality of source lines SL. The switching circuit 250 may control the connection between the plurality of channel lines CHL and the plurality of source lines SL by controlling the operation of a plurality of switches. The switching circuit 250 may output the channel signal SIG_CH received from the source driver 230 as the source signal SIG_S to the pixel array 100.

The gate driver 270 is connected to the plurality of gate lines GL of the pixel array 100 and may sequentially drive the plurality of gate lines GL of the pixel array 100. The gate driver 270 may provide a plurality of gate signals G0, G1, G2, . . . , Gh−1 to the pixel array 100. The plurality of gate signals G0, G1, G2, . . . , Gh−1 may be pulse signals having an enable level and a disable level. The plurality of gate signals G0, G1, G2, . . . , Gh−1 may be applied to a plurality of gate lines GL.

The gate driver 270 may apply the plurality of gate signals G0, G1, G2, . . . , Gh−1 to the plurality of gate lines GL in different ways based on the control signal CONT1 of the driving controller 210. In an example case in which an enable level gate signal is applied to the pixel PX connected to one of the plurality of gate lines GL, the source signal applied to the source line connected to the corresponding pixel PX among the plurality of source lines SL may be transmitted to the pixel PX.

In FIG. 2, the driving controller 210, the source driver 230, the switching circuit 250, and the gate driver 270 are shown as different functional blocks according to an embodiment. In some embodiments, each component may be implemented with a different semiconductor chip. Meanwhile, in another embodiment, at least two components of the driving controller 210, source driver 230, switching circuit 250, and gate driver 270 may be implemented as one semiconductor chip. For example, the source driver 230, switching circuit 250, and gate driver 270 may be integrated into one semiconductor chip. Additionally, some components may be integrated on the pixel array 100. For example, the gate driver 270 may be integrated on the pixel array 100.

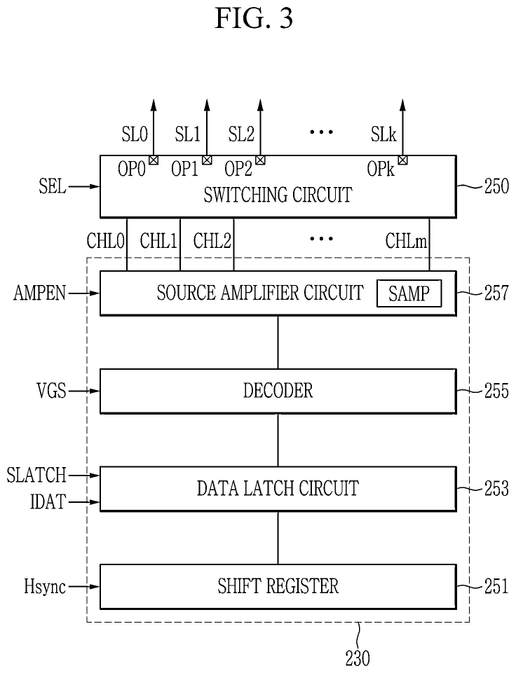

FIG. 3 is a block diagram of a source driver 230 and switching circuit 250 according to an embodiment.

As shown in FIG. 3, the source driver 230 may include a shift register 251, a data latch circuit 253, a decoder 255, and a source amplifier circuit 257. The source driver 230 may receive the control signal CONT2 from the driving controller (210 in FIG. 2). The control signal CONT2 may include a horizontal synchronization signal Hsync, a latch signal SLATCH, a gamma voltage signal VGS and an activation signal AMPEN. The components 251, 253, and 255 of the source driver 230 are not limited to the illustration in FIG. 3, and as such, according to another embodiment the components may be modified into various other forms. For example, according to another embodiment, various components may be added or two or more of the components may be combined.

The shift register 251 may receive the horizontal synchronization signal Hysnc from the driving controller 210. The shift register 251 may control the operation timing of each of the plurality of sampling circuits included in the data latch circuit 253 in response to the horizontal synchronization signal Hsync. The horizontal synchronization signal Hsync may be a signal having a first period. The first period may be a predetermined period.

The data latch circuit 253 may receive image data IDAT and the latch signal SLATCH from the driving controller 210. For example, the latch signal SLATCH may be a signal indicating that new data to be output by the source driver 230 has been received to the data latch circuit 253. In another example, the latch signal SLATCH may be a signal indicating that data stored in the data latch circuit 253 has been updated. The data latch circuit 253 may sample and store image data IDAT. The data latch circuit 253 may transmit sampled image data to the decoder 255. In some embodiments, the data latch circuit 253 may include a sampling circuit that samples data and a holding latch that stores data sampled by the sampling circuit.

The decoder 255 may receive sampled image data from the data latch circuit 253. Additionally, the decoder 255 may receive a gamma voltage signal VGS. In some embodiments, the display driving circuit (200 in FIG. 1) may further include a gamma voltage generator that generates the gamma voltage signal VGS corresponding to various levels of luminance. The number of gamma voltages VG may be determined based on the number of colors to be displayed through the display panel (100 in FIG. 1) or the number of bits of digital data provided from outside the display device (10 in FIG. 1).

The decoder 255 may select one of the gamma voltages VG in response to sampled image data. For example, the decoder 255 may select one of the gamma voltages VG based on the sampled image data and the gamma voltage signal VGS. The decoder 255 may output the selected gamma voltage to the source amplifier circuit 257. In some embodiments, the decoder 255 may be implemented as a digital-to-analog converter.

The source amplifier circuit 257 may receive the selected gamma voltage VG from the decoder 255. The source amplifier circuit 257 may receive the activation signal AMPEN from the driving controller (210 in FIG. 2). The source amplifier circuit 257 may include a source amplifier SAMP connected to one of the plurality of channel lines CHL. The source amplifier SAMP may be implemented as an operational amplifier. The source amplifier circuit 257 may amplify the selected gamma voltage received from the decoder 255 in response to the activation signal AMPEN. The source amplifier circuit 257 may transmit the amplified voltage as a data voltage (or gray voltage) to the switching circuit 250 through a plurality of channel lines CHL0 to CHLm.

The switching circuit 250 may receive data voltages from the source amplifier circuit 257. The switching circuit 250 may receive the selection signal SEL from the driving controller 210. The switching circuit 250 may include an output switch connected to the source amplifier SAMP. The switching circuit 250 may transmit data voltages to a plurality of pixels of the pixel array (100 in FIG. 2) through a plurality of source lines SL0 to SLk in response to the selection signal SEL.

In some embodiments, the switching circuit 250 may include a plurality of output pads OP0 to OPk. Each of the plurality of output pads OP0 to OPk may be connected to a corresponding source line among the plurality of source lines SL0 to SLk. The plurality of output pads OP0 to OPk may receive corresponding channel signals from the source amplifier circuit 257. The plurality of output pads OP0 to OPk may output channel signals as source signals to the pixel array (100 in FIG. 2).

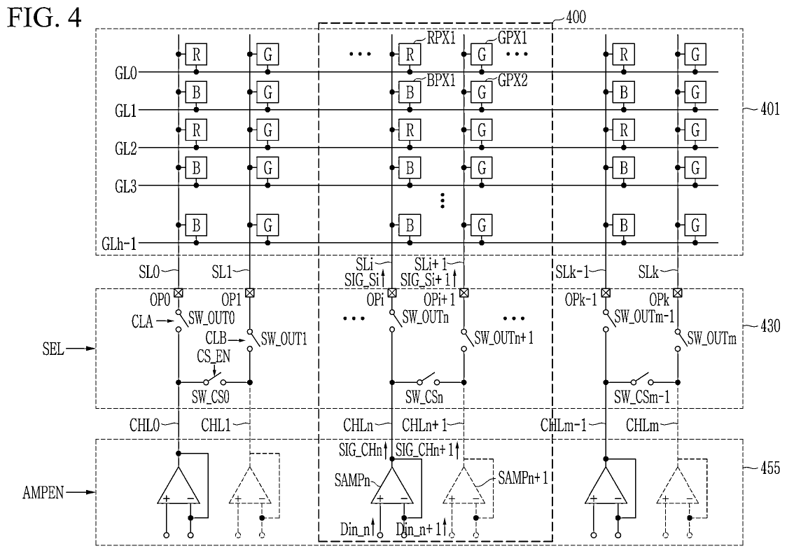

FIG. 4 is a diagram showing parts of a display device according to an embodiment. For example, FIG. 4 is a diagram showing a pixel array 401, a switching circuit 430, and a source amplifier circuit 455.

Referring to FIG. 4, the pixel array 401 may have a structure in which red pixels (e.g., RPX1) and green pixels (e.g., GPX1) are repeatedly arranged in odd-numbered pixel rows, and blue pixels (e.g., BPX1) and green pixels (e.g., GPX2) are repeatedly arranged in even-numbered pixel rows. The pixel array 401 may have an RGBG pixel arrangement structure. In some embodiments, the RGBG pixel arrangement structure may be referred to as an RGBG Pentile™ structure. However, the disclosure is not limited thereto, and as such, according to another embodiment, the pixel array 401 may have a structure in which red pixels (e.g., RPX1) and green pixels (e.g., GPX1) are repeatedly arranged in even-numbered pixel rows, and blue pixels (e.g., BPX1) and green pixels (e.g., GPX2) are repeatedly arranged in odd-numbered pixel rows.

The source amplifier circuit 455 may include an nth source amplifier SAMPn connected to an nth channel line CHLn and an n+1th source amplifier SAMPn+1 connected to an n+1th channel line CHLn+1.

The nth source amplifier SAMPn may be turned on in response to the activation signal AMPEN and may generate an nth channel signal SIG_CHn based on an nth input data Din_n. The n+1th source amplifier SAMPn+1 may be turned on in response to the activation signal AMPEN and may generate an n+1th channel signal SIG_CHn+1 based on an n+1th input data Din_n+1.

In some embodiments, the nth input data Din_n and the n+1th input data Din_n+1 may be converted into gray voltages through the decoder (255 in FIG. 3), and the pixel signals corresponding to the nth input data Din_n and the n+1th input data Din_n+1 may be provided to the nth source amplifier SAMPn and the n+1th source amplifier SAMPn+1, respectively.

The switching circuit 430 may control the output path of the output signals of the source amplifier circuit 455. The switching circuit 430 may include an nth output switch SW_OUTn, an n+1th output switch SW_OUTn+1, and a connection switch SW_CSn.

The nth output switch SW_OUTn may be connected between an output node of the nth source amplifier SAMPn and an ith output pad OPi. The nth output switch SW_OUTn may be turned on in response to a first switch control signal CLA, and may provide the output of the nth source amplifier SAMPn (i.e., the nth channel signal SIG_CHn) to the ith output pad OPi. Accordingly, the nth channel signal SIG_CHn may be provided to the pixel array 401 as an ith source signal SIG_Si. The ith source signal SIG_Si may be provided to the red pixel (e.g., RPX1) and the blue pixel (e.g., BPX1) of the pixel array 401 through an ith source line SLi.

The n+1th output switch SW_OUTn+1 may be connected between the output node of the n+1th source amplifier SAMPn+1 and an i+1th output pad OPi+1. The n+1th output switch SW_OUTn+1 may be turned on in response to a second switch control signal CLB, and may provide the output of the n+1th source amplifier SAMPn+1 (i.e., the n+1th channel signal SIG_CHn+1) to an i+1th output pad OPi+1. Accordingly, the n+1th channel signal SIG_CHn+1 may be provided to the pixel array 401 as an i+1th source signal SIG_Si+1. The i+1th source signal SIG_Si+1 may be provided to the green pixel (e.g., GPX1 and GPX2) of the pixel array 401 through an i+1th source line SLi+1.

The connection switch SW_CSn may be connected between the output node of the nth source amplifier SAMPn and the output node of the n+1th source amplifier SAMPn+1. The connection switch SW_CSn may be turned on in response to a third switch control signal CS_EN, so that the output of the nth source amplifier SAMPn (i.e., the nth channel signal SIG_CHn) may be provided to one end of the n+1th output switch SW_OUTn+1, or the output of the n+1th source amplifier SAMPn+1 (i.e., the n+1th channel signal SIG_CHn+1) may be provided to one end of the nth output switch SW_OUTn. That is, the nth channel signal SIG_CHn may be provided to the pixel array 401 as the ith source signal SIG_Si and the i+1th source signal SIG_Si+1, or the n+1th channel signal SIG_CHn+1 may be provided to the pixel array 401 as the ith source signal SIG_Si and the i+1th source signal SIG_Si+1. Meanwhile, in some embodiments, the source amplifier circuit 455 may not include the n+1th source amplifier SAMPn+1. In an example case in which the source amplifier circuit 455 does not include the n+1th source amplifier SAMPn+1, the driving controller (210 in FIG. 2) may control the switching circuit 430 to provide the nth channel signal SIG_CHn as the ith source signal SIG_Si and the i+1th source signal SIG_Si+1 to the pixel array 401 while the connection switch SW_CSn is turned on through the selection signal SEL. Accordingly, the red pixel (e.g., RPX1), blue pixel (e.g., BPX1), and green pixel (e.g., GPX1 and GPX2) may be controlled by the same source signal.

For example, the driving controller (210 in FIG. 2) may control an operation status of the nth source amplifier SAMPn and the n+1th source amplifier SAMPn+1 based on the activation signal AMPEN, and may control the output path of the output of the nth source amplifier SAMPn and the n+1th source amplifier SAMPn+1 based on the selection signal SEL.

In some embodiments, the nth source amplifier SAMPn may generate the source signal SIG_Si to sequentially drive a red pixel RPX1, a green pixel GPX1, a blue pixel BPX1, and a green pixel GPX2. For example, the nth source amplifier SAMPn may generate the source signal SIG_Si to drive the green pixels GPX1 and GPX2 to output green color. In an example case in which the driving controller (210 in FIG. 2) generates an 8-bit gray voltage, the source signal SIG_Si may sequentially toggle with values of 0, 255, 0, and 255 during the horizontal period.

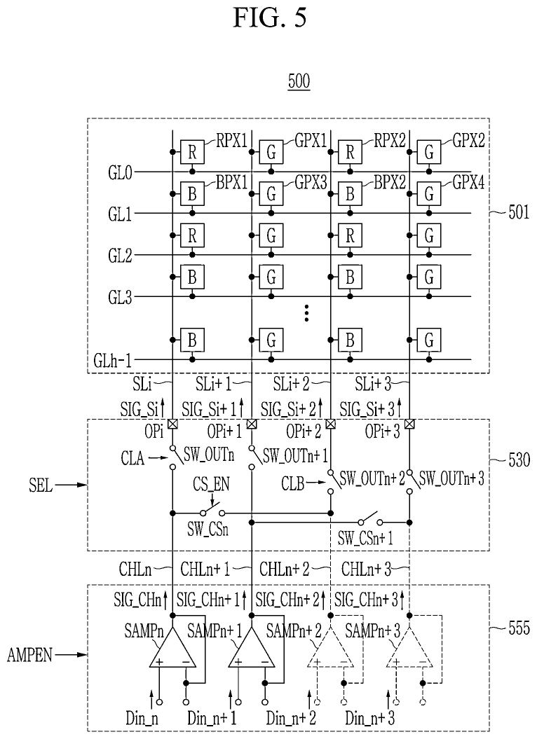

FIG. 5 is a diagram showing parts of a display device according to an embodiment.

According to an embodiment, a display device 500 may include a pixel array 501, a switching circuit 530, and a source amplifier circuit 555. For example, FIG. 5 is a diagram showing parts of the pixel array 501, the switching circuit 530, and the source amplifier circuit 555.

The pixel array 501 may have a structure in which red pixels (e.g., RPX1) and green pixels (e.g., GPX1) are repeatedly arranged in odd-numbered pixel rows, and blue pixels (e.g., BPX1) and green pixels (e.g., GPX2) are repeatedly arranged in even-numbered pixel rows.

The source amplifier circuit 555 may include the nth source amplifier SAMPn connected to the nth channel line CHLn, the n+1th source amplifier SAMPn+1 connected to the n+1th channel line CHLn+1, an n+2th source amplifier SAMPn+2 connected to a n+2th channel line CHLn+2, and an n+3th source amplifier SAMPn+3 connected to an n+3th channel line CHLn+3.

The nth source amplifier SAMPn may be turned on in response to the activation signal AMPEN and may generate an nth channel signal SIG_CHn based on an nth input data Din_n. The n+1th source amplifier SAMPn+1 may be turned on in response to the activation signal AMPEN and may generate an n+1th channel signal SIG_CHn+1 based on an n+1th input data Din_n+1. The n+2th source amplifier SAMPn+2 may be turned on in response to the activation signal AMPEN and may generate an n+2th channel signal SIG_CHn+2 based on an n+2th input data Din_n+2. The n+3th source amplifier SAMPn+3 may be turned on in response to the activation signal AMPEN and may generate an n+3th channel signal SIG_CHn+3 based on an n+3th input data Din_n+3.

In some embodiments, the nth input data Din_n, the n+1th input data Din_n+1, the n+2th input data Din_n+2, and the n+3th input data Din_n+3 may be converted into gray voltages through the decoder (255 in FIG. 3), and pixel signals corresponding to the nth input data Din_n, the n+1th input data Din_n+1, the n+2th input data Din_n+2, and the n+3th input data Din_n+3 may be provided to the nth source amplifier SAMPn, the n+1th source amplifier SAMPn+1, the n+2th source amplifier SAMPn+2, and the n+3th source amplifier SAMPn+3, respectively.

The switching circuit 530 may control the output path of the output signals of the source amplifier circuit 555. The switching circuit 530 may include a plurality of output switches that selectively connect the plurality of channel lines CHL of the source amplifier circuit 555 to the plurality of source lines SL. For example, the switching circuit 530 may include the nth output switch SW_OUTn, the n+1th output switch SW_OUTn+1, the n+2th output switch SW_OUTn+2, and the n+3th output switch SW_OUTn+3. Additionally, the switching circuit 530 may include a plurality of connection switches SW_CSn and SW_CSn+1 connecting the plurality of channel lines CHL to each other. For example, the switching circuit 530 may include the connection switch SW_CSn connecting two of the channel lines CHL with each other and the connection switch SW_CSn+1 connecting another two of the channel lines CHL with each other. However, the disclosure is not limited thereto, and as such, according to another embodiment, two or more connections switches may be provided.

An output switch SW_OUTq (q is an integer greater than or equal to 0 and less than or equal to m) may be connected between the output node of the corresponding source amplifier SAMPq and the corresponding output pad OPq.

For example, the nth output switch SW_OUTn may be connected between the output node of the nth source amplifier SAMPn and the ith output pad OPi. The nth output switch SW_OUTn may be turned on in response to a first switch control signal CLA, and may provide the output of the nth source amplifier SAMPn (i.e., the nth channel signal SIG_CHn) to the ith output pad OPi. Accordingly, the nth channel signal SIG_CHn may be provided to the pixel array 501 as the ith source signal SIG_Si. The ith source signal SIG_Si may be provided to the red pixel (e.g., RPX1) and the blue pixel (e.g., BPX1) of the pixel array 401 through an ith source line SLi.

The n+1th output switch SW_OUTn+1 may be connected between the output node of the n+1th source amplifier SAMPn+1 and an i+1th output pad OPi+1. The n+1th output switch SW_OUTn+1 may be turned on in response to the first switch control signal CLA, and may provide the output of the n+1th source amplifier SAMPn+1 (i.e., the n+1th channel signal SIG_CHn+1) to the i+1th output pad OPi+1. Accordingly, the n+1th channel signal SIG_CHn+1 may be provided to the pixel array 501 as an i+1th source signal SIG_Si+1. The i+1th source signal SIG_Si+1 may be provided to the green pixel (e.g., GPX1 and GPX3) of the pixel array 401 through the i+1th source line SLi+1.

The n+2th output switch SW_OUTn+2 may be connected between the output node of the n+2th source amplifier SAMPn+2 and an i+2th output pad OPi+2. The n+2th output switch SW_OUTn+2 may be turned on in response to the second switch control signal CLB, and may provide the output of the n+2th source amplifier SAMPn+2 (i.e., the n+2th channel signal SIG_CHn+2) to the i+2th output pad OPi+2. Accordingly, the n+2th channel signal SIG_CHn+2 may be provided to the pixel array 501 as an i+2th source signal SIG_Si+2. The i+2th source signal SIG_Si may be provided to the red pixel (e.g., RPX2) and the blue pixel (e.g., BPX2) of the pixel array 401 through an i+2th source line SLi+2.

The n+3th output switch SW_OUTn+3 may be connected between the output node of the n+3th source amplifier SAMPn+3 and an i+3th output pad OPi+3. The n+3th output switch SW_OUTn+3 may be turned on in response to the second switch control signal CLB, and may provide the output of the n+3th source amplifier SAMPn+3 (i.e., the n+3th channel signal SIG_CHn+3) to the i+3th output pad OPi+3. Accordingly, the n+3th channel signal SIG_CHn+3 may be provided to the pixel array 501 as an i+3th source signal SIG_Si+3. The i+3th source signal SIG_Si+3 may be provided to the green pixel (e.g., GPX2 and GPX4) of the pixel array 401 through the i+3th source line SLi+3.

In some embodiments, as shown in FIG. 5, the connection switch SW_CSn+1 may be provided between the source lines SLi+1 and SLi+3 connected to the green pixels GPX1 and GPX2, and the connection switch SW_CSn may be provided between the source lines SLi and SLi+2 connected to the red and blue pixels RPX1, RPX2, BPX1 and BPX2.

The connection switch SW_CSn may be connected between the output node of the nth source amplifier SAMPn and the output node of the n+2th source amplifier SAMPn+2. The connection switch SW_CSn may be turned on in response to the third switch control signal CS_EN, so that the output of the nth source amplifier SAMPn (i.e., the nth channel signal SIG_CHn) may be provided to one end of the n+2th output switch SW_OUTn+2, or the output of the n+2th source amplifier SAMPn+2 (i.e., the n+2th channel signal SIG_CHn+2) may be provided to one end of the nth output switch SW_OUTn. That is, the nth channel signal SIG_CHn may be provided to the pixel array 501 as the ith source signal SIG_Si and the i+2th source signal SIG_Si+2, or the n+2th channel signal SIG_CHn+2 may be provided to the pixel array 501 as the ith source signal SIG_Si and the i+2th source signal SIG_Si+2. Meanwhile, in some embodiments, the source amplifier circuit 555 may not include the n+2th source amplifier SAMPn+2. In an example case in which the source amplifier circuit 555 does not include the n+2th source amplifier SAMPn+2, the display device 500 may provide the nth channel signal SIG_CHn as the ith source signal SIG_Si and the i+2th source signal SIG_Si+2 to the pixel array 501 while the connection switch SW_CSn is turned on. Accordingly, the red pixel (e.g., RPX1 and RPX2) and blue pixel (e.g., BPX1 and BP2) may be controlled by the same source signal.

The connection switch SW_CSn+1 may be connected between the output node of the n+1th source amplifier SAMPn+1 and the output node of the n+3th source amplifier SAMPn+3. The connection switch SW_CSn+1 may be turned on in response to the third switch control signal CS_EN, so that the output of the n+1th source amplifier SAMPn+1 (i.e., the n+1th channel signal SIG_CHn+1) may be provided to one end of the n+3th output switch SW_OUTn+3, or the output of the n+3th source amplifier SAMPn+3 (i.e., the n+3th channel signal SIG_CHn+3) may be provided to one end of the n+1th output switch SW_OUTn+1. That is, the n+1th channel signal SIG_CHn+1 may be provided to the pixel array 501 as the i+1th source signal SIG_Si+1 and the i+3th source signal SIG_Si+3, or the n+3th channel signal SIG_CHn+3 may be provided to the pixel array 501 as the i+1th source signal SIG_Si+1 and the i+3th source signal SIG_Si+3. Meanwhile, in some embodiments, the source amplifier circuit 555 may not include the n+3th source amplifier SAMPn+3. In an example case in which the source amplifier circuit 555 does not include the n+3th source amplifier SAMPn+3, the display device 500 may provide the n+1th channel signal SIG_CHn+1 as the i+1th source signal SIG_Si+1 and the i+3th source signal SIG_Si+3 to the pixel array 501 while the connection switch SW_CSn+1 is turned on. Accordingly, the green pixels GPX1, GPX2, GPX3 and GPX4 may be controlled by the same source signal.

For example, the driving controller (210 in FIG. 2) may control the operation status of the nth source amplifier SAMPn and the n+2th source amplifier SAMPn+2 based on the activation signal AMPEN, and may control the output path of the output of the nth source amplifier SAMPn and the n+2th source amplifier SAMPn+2 based on the selection signal SEL.

In some embodiments, the nth source amplifier SAMPn may generate the channel signal SIG_CHn to sequentially drive the red pixel RPX1, the red pixel RPX2, the blue pixel BPX1, and the blue pixel BPX2. The switching circuit 530 may alternately provide the channel signal SIG_CHn to the source signal SIG_Si and the source signal SIG_Si+2 according to the selection signal SEL.

In addition, the n+1th source amplifier SAMPn+1 may generate the channel signal SIG_CHn+1 to sequentially drive the green pixel GPX1, the green pixel GPX2, a green pixel GPX3, and the green pixel GPX4. At this time, the switching circuit 530 may alternately provide the channel signal SIG_CHn+1 to the source signal SIG_Si+1 and the source signal SIG_Si+3 by the selection signal SEL. Accordingly, the display device 500 may generate the channel signal SIG_CHn+1 of an enable level to output green color. Since the green pixel is driven by the source signal generated by one source amplifier, the voltage of the source signal SIG_Si does not change, and the display device 400 may output green color while consuming little power.

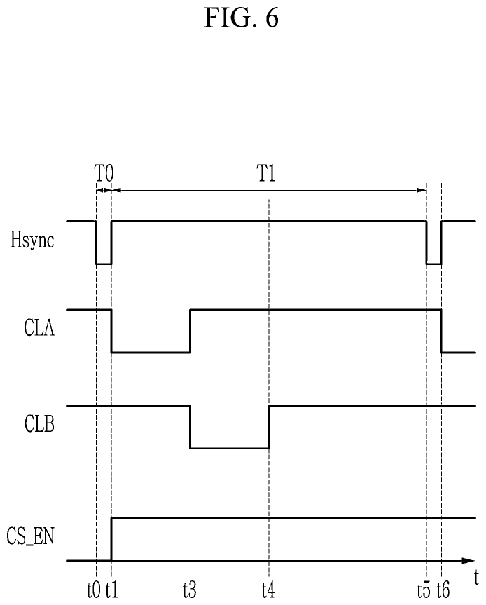

FIG. 6 is a timing diagram showing the operation of the switching circuit according to FIG. 5.

For example, FIG. 6 is a timing diagram showing the operation of the display device according to FIG. 5.

The display device 500 may operate in a first period T0 and a second period T1. The first period T0 may be a period in which image data is not output to the pixel array 501. In the first period T0, the horizontal synchronization signal Hsync may be turned off.

The second period T1 may be an image output period in which image data is output to the pixel array 501. In the second period T1, the horizontal synchronization signal Hsync may be turned on.

For example, at t1, the nth output switch SW_OUTn and the n+1th output switch SW_OUTn+1 may be turned on by the first switch selection signal CLA of the enable level. Accordingly, the nth source amplifier SAMPn may output the generated channel signal SIG_CHn as the source signal SIG_Si to the ith source line SLi, and the n+1th source amplifier SAMPn+1 may output the generated channel signal SIG_CHn+1 as the source signal SIG_Si+1 to the i+1th source line SLi+1. Although FIG. 6 illustrates an example in which the enable level is indicated by a low level, the disclosure is not limited thereto. As such, according to another example, the enable level may be indicate by a high level.

At this time, the connection switch SW_CSn may be turned on by the third switch control signal CS_EN at the enable level. Accordingly, in an example case in which the second switch selection signal CLB is changed to the enable level and the first switch selection signal CLA is change to a disable level, the channel signal SIG_CHn may be output as the source signal SIG_Si+2 to the i+2th source line SLi+2, and the channel signal SIG_CHn+1 may be output as the source signal SIG_Si+3 to the i+3th source line SLi+3.

For example, at t3, the n+2th output switch SW_OUTn+2 and the n+3th output switch SW_OUTn+3 may be turned on by the second switch selection signal CLB of the enable level. At the same time, the nth output switch SW_OUTn and the n+1th output switch SW_OUTn+1 may be turned off by the first switch selection signal CLA of the disable level. Accordingly, the nth source amplifier SAMPn may output the generated channel signal SIG_CHn as the source signal the source signal SIG_Si to the i+2th source line SLi+2, and the n+1th source amplifier SAMPn+1 may output the generated channel signal SIG_CHn+1 as the source signal SIG_Si+1 to the i+3th source line SLi+3.

At this time, the connection switch SW_CSn may be kept turned on by the enable third switch control signal CS_EN. In another example case in which the second switch selection signal CLB is changed to the disable level and the first switch selection signal CLA is changed to an enable level, the channel signal SIG_CHn+2 may be output as the source signal SIG_Si+2 to the ith source line SLi, and the channel signal SIG_CHn+3 may be output as the source signal SIG_Si+1 to the i+1th source line SLi+1. In another example case in which the connection switch SW_CSn is turned off, the second switch selection signal CLB is changed to the enable level and the first switch selection signal CLA is changed to a disable level, the channel signal SIG_CHn+2 may be output as the source signal SIG_Si+2 to the i+2th source line SLi+2, and the channel signal SIG_CHn+3 may be output as the source signal SIG_Si+3 to the i+3th source line SLi+3.

Referring to FIG. 6, the display device 500 may repeatedly perform the first period T0 and the second period T1. For example, at t5, the display device may start a new period similar to the first period T0, and at t6, the display device may start a new period similar to the second period T1. For example, between t5 and t6, the horizontal synchronization signal Hsync may be turned off, and after t6, the horizontal synchronization signal Hsync may be turned on.

Meanwhile, the order in which the first switch selection signal CLA and the second switch selection signal CLB are generated is not limited thereto. As such, according to another embodiment, the order of the first switch selection signal CLA and the second switch selection signal CLB may be different. In another embodiment, the first switch selection signal CLA and the second switch selection signal CLB may be turned on and turned off at different times.

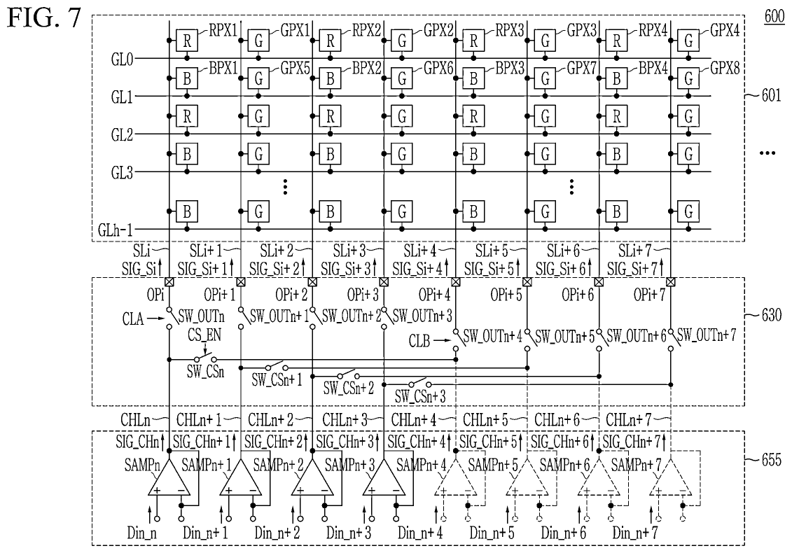

FIG. 7 is a diagram showing parts of a display device according to an embodiment.

A display device 600 may include a pixel array 601, a switching circuit 630, and a source amplifier circuit 655. For example, FIG. 6 is a diagram showing parts of the pixel array 601, the switching circuit 630, and the source amplifier circuit 655.

The pixel array 601 may have a structure in which red pixels (e.g., RPX1) and green pixels (e.g., GPX1) are repeatedly arranged in odd-numbered pixel rows, and blue pixels (e.g., BPX1) and green pixels (e.g., GPX2) are repeatedly arranged in even-numbered pixel rows.

The source amplifier circuit 655 may include the nth source amplifier SAMPn connected to the nth channel line CHLn, the n+1th source amplifier SAMPn+1 connected to the n+1th channel line CHLn+1, the n+2th source amplifier SAMPn+2 connected to the n+2th channel line CHLn+2, the n+3th source amplifier SAMPn+3 connected to the n+3th channel line CHLn+3, a n+4th source amplifier SAMPn+4 connected to a n+4th channel line CHLn+4, a n+5th source amplifier SAMPn+5 connected to a n+5th channel line CHLn+5, a n+6th source amplifier SAMPn+6 connected to a n+6th channel line CHLn+6, and a n+7th source amplifier SAMPn+7 connected to a n+7th channel line CHLn+7.

The nth source amplifier SAMPn may be turned on in response to the activation signal AMPEN and may generate the nth channel signal SIG_CHn based on the nth input data Din_n. The n+1th source amplifier SAMPn+1 may be turned on in response to the activation signal AMPEN and may generate the n+1th channel signal SIG_CHn+1 based on the n+1th input data Din_n+1. The n+2th source amplifier SAMPn+2 may be turned on in response to the activation signal AMPEN and may generate the n+2th channel signal SIG_CHn+2 based on the n+2th input data Din_n+2. The n+3th source amplifier SAMPn+3 may be turned on in response to the activation signal AMPEN and may generate the n+3th channel signal SIG_CHn+3 based on the n+3th input data Din_n+3. The n+4th source amplifier SAMPn+4 may be turned on in response to the activation signal AMPEN and may generate an n+4th channel signal SIG_CHn+4 based on an n+4th input data Din_n+4. The n+5th source amplifier SAMPn+5 may be turned on in response to the activation signal AMPEN and may generate an n+5th channel signal SIG_CHn+5 based on an n+5th input data Din_n+5. The n+6th source amplifier SAMPn+6 may be turned on in response to the activation signal AMPEN and may generate an n+6th channel signal SIG_CHn+6 based on an n+6th input data Din_n+6. The n+7th source amplifier SAMPn+7 may be turned on in response to the activation signal AMPEN and may generate an n+7th channel signal SIG_CHn+7 based on an n+7th input data Din_n+7.

In some embodiments, the nth input data Din_n, the n+1th input data Din_n+1, the n+2th input data Din_n+2, the n+3th input data Din_n+3, the n+4th input data Din_n+4, the n+5th input data Din_n+5, the n+6th input data Din_n+6, and the n+7th input data Din_n+7 may be converted into gray voltages through the decoder (255 in FIG. 3), and pixel signals corresponding to the nth input data Din_n, the n+1th input data Din_n+1, the n+2th input data Din_n+2, the n+3th input data Din_n+3, the n+4th input data Din_n+4, the n+5th input data Din_n+5, the n+6th input data Din_n+6, and the n+7th input data Din_n+7 may be provided to the nth source amplifier SAMPn, the n+1th source amplifier SAMPn+1, the n+2th source amplifier SAMPn+2, the n+3th source amplifier SAMPn+3, the n+4th source amplifier SAMPn+4, the n+5th source amplifier SAMPn+5, the n+6th source amplifier SAMPn+6, and the n+7th source amplifier SAMPn+7 respectively.

The switching circuit 630 may control the output path of the output signals of the source amplifier circuit 655. The switching circuit 630 may include the nth output switch SW_OUTn, the n+1th output switch SW_OUTn+1, the n+2th output switch SW_OUTn+2, the n+3th output switch SW_OUTn+3, the n+4th output switch SW_OUTn+4, the n+5th output switch SW_OUTn+5, the n+6th output switch SW_OUTn+6, the n+7th output switch SW_OUTn+7, the connection switch SW_CSn, the connection switch SW_CSn+1, a connection switch SW_CSn+2, and a connection switch SW_CSn+3.

The output switch SW_OUTq (q is an integer greater than or equal to 0 and less than or equal to m) may be connected between the output node of the corresponding source amplifier SAMPq and the corresponding output pad OPq.

The nth output switch SW_OUTn may be connected between the output node of the nth source amplifier SAMPn and the ith output pad OPi. The nth output switch SW_OUTn may be turned on in response to a first switch control signal CLA, and may provide the output of the nth source amplifier SAMPn (i.e., the nth channel signal SIG_CHn) to the ith output pad OPi. Accordingly, the nth channel signal SIG_CHn may be provided to the pixel array 601 as the ith source signal SIG_Si. The ith source signal SIG_Si may be provided to the red pixel (e.g., RPX1) and the blue pixel (e.g., BPX1) of the pixel array 601 through an ith source line SLi.

The n+1th output switch SW_OUTn+1 may be connected between the output node of the n+1th source amplifier SAMPn+1 and an i+1th output pad OPi+1. The n+1th output switch SW_OUTn+1 may be turned on in response to the first switch control signal CLA, and may provide the output of the n+1th source amplifier SAMPn+1 (i.e., the n+1th channel signal SIG_CHn+1) to the i+1th output pad OPi+1. Accordingly, the n+1th channel signal SIG_CHn+1 may be provided to the pixel array 601 as an i+1th source signal SIG_Si+1. The i+1th source signal SIG_Si+1 may be provided to the green pixel (e.g., GPX1 and GPX5) of the pixel array 601 through the i+1th source line SLi+1.

The n+2th output switch SW_OUTn+2 may be connected between the output node of the n+2th source amplifier SAMPn+2 and an i+2th output pad OPi+2. The n+2th output switch SW_OUTn+2 may be turned on in response to the first switch control signal CLA, and may provide the output of the n+2th source amplifier SAMPn+2 (i.e., the n+2th channel signal SIG_CHn+2) to the i+2th output pad OPi+2. Accordingly, the n+2th channel signal SIG_CHn+2 may be provided to the pixel array 601 as the i+2th source signal SIG_Si+2. The i+2th source signal SIG_Si may be provided to the red pixel (e.g., RPX2) and the blue pixel (e.g., BPX2) of the pixel array 601 through an i+2th source line SLi+2.

The n+3th output switch SW_OUTn+3 may be connected between the output node of the n+3th source amplifier SAMPn+3 and an i+3th output pad OPi+3. The n+3th output switch SW_OUTn+3 may be turned on in response to the first switch control signal CLA, and may provide the output of the n+3th source amplifier SAMPn+3 (i.e., the n+3th channel signal SIG_CHn+3) to the i+3th output pad OPi+3. Accordingly, the n+3th channel signal SIG_CHn+3 may be provided to the pixel array 601 as the i+3th source signal SIG_Si+3. The i+3th source signal SIG_Si+3 may be provided to the green pixel (e.g., GPX2 and GPX6) of the pixel array 601 through the i+3th source line SLi+3.

The n+4th output switch SW_OUTn+4 may be connected between the output node of the n+4th source amplifier SAMPn+4 and an i+4th output pad OPi+4. The n+4th output switch SW_OUTn+4 may be turned on in response to the second switch control signal CLB, and may provide the output of the n+4th source amplifier SAMPn+4 (i.e., the n+4th channel signal SIG_CHn+4) to the i+4th output pad OPi+4. Accordingly, the n+4th channel signal SIG_CHn+4 may be provided to the pixel array 601 as the i+4th source signal SIG_Si+4. The i+4th source signal SIG_Si+4 may be provided to the red pixel (e.g., RPX3) and the blue pixel (e.g., BPX3) of the pixel array 601 through the i+4th source line SLi+4.

The n+5th output switch SW_OUTn+5 may be connected between the output node of the n+5th source amplifier SAMPn+5 and an i+5th output pad OPi+5. The n+5th output switch SW_OUTn+5 may be turned on in response to the second switch control signal CLB, and may provide the output of the n+5th source amplifier SAMPn+5 (i.e., the n+5th channel signal SIG_CHn+5) to the i+5th output pad OPi+5. Accordingly, the n+5th channel signal SIG_CHn+5 may be provided to the pixel array 601 as the i+5th source signal SIG_Si+5. The i+5th source signal SIG_Si+5 may be provided to the green pixel (e.g., GPX3 and GPX7 of the pixel array 601 through the i+5th source line SLi+5.

The n+6th output switch SW_OUTn+6 may be connected between the output node of the n+6th source amplifier SAMPn+6 and an i+6th output pad OPi+6. The n+6th output switch SW_OUTn+6 may be turned on in response to the second switch control signal CLB, and may provide the output of the n+6th source amplifier SAMPn+6 (i.e., the n+6th channel signal SIG_CHn+6) to the i+6th output pad OPi+6. Accordingly, the n+6th channel signal SIG_CHn+6 may be provided to the pixel array 601 as the i+6th source signal SIG_Si+6. The i+6th source signal SIG_Si+6 may be provided to the red pixel (e.g., RPX4) and the blue pixel (e.g., BPX4) of the pixel array 601 through the i+6th source line SLi+6.

The n+7th output switch SW_OUTn+7 may be connected between the output node of the n+7th source amplifier SAMPn+7 and an i+7th output pad OPi+7. The n+7th output switch SW_OUTn+7 may be turned on in response to the second switch control signal CLB, and may provide the output of the n+7th source amplifier SAMPn+7 (i.e., the n+7th channel signal SIG_CHn+7) to the i+7th output pad OPi+7. Accordingly, the n+7th channel signal SIG_CHn+7 may be provided to the pixel array 601 as the i+7th source signal SIG_Si+7. The i+7th source signal SIG_Si+7 may be provided to the green pixel (e.g., GPX4 and GPX8) of the pixel array 601 through the i+7th source line SLi+7.

The connection switch SW_CSn may be connected between the output node of the nth source amplifier SAMPn and the output node of the n+4th source amplifier SAMPn+4. The connection switch SW_CSn may be turned on in response to the third switch control signal CS_EN, so that the output of the nth source amplifier SAMPn (i.e., the nth channel signal SIG_CHn) may be provided to one end of the n+4th output switch SW_OUTn+4, or the output of the n+4th source amplifier SAMPn+4 (i.e., the n+4th channel signal SIG_CHn+4) may be provided to one end of the nth output switch SW_OUTn. That is, the nth channel signal SIG_CHn may be provided to the pixel array 601 as the ith source signal SIG_Si and the i+4th source signal SIG_Si+4, or the n+4th channel signal SIG_CHn+4 may be provided to the pixel array 601 as the ith source signal SIG_Si and the i+4th source signal SIG_Si+4. Meanwhile, in some embodiments, the source amplifier circuit 655 may not include the n+4th source amplifier SAMPn+4. In an example case in which the source amplifier circuit 655 does not include the n+4th source amplifier SAMPn+4, the display device 600 may provide the nth channel signal SIG_CHn as the ith source signal SIG_Si and the i+4th source signal SIG_Si+4 to the pixel array 601 while the connection switch SW_CSn is turned on. Accordingly, the red pixel (e.g., RPX1 and RPX3) and blue pixel (e.g., BPX1 and BP3) may be controlled by the same source signal.

The connection switch SW_CSn+1 may be connected between the output node of the n+1th source amplifier SAMPn+1 and the output node of the n+5th source amplifier SAMPn+5. The connection switch SW_CSn+1 may be turned on in response to the third switch control signal CS_EN, so that the output of the n+1th source amplifier SAMPn+1 (i.e., the n+1th channel signal SIG_CHn+1) may be provided to one end of the n+5th output switch SW_OUTn+5, or the output of the n+5th source amplifier SAMPn+5 (i.e., the n+5th channel signal SIG_CHn+5) may be provided to one end of the n+1th output switch SW_OUTn+1. That is, the n+1th channel signal SIG_CHn+1 may be provided to the pixel array 601 as the i+1th source signal SIG_Si+1 and the i+5th source signal SIG_Si+5, or the n+5th channel signal SIG_CHn+5 may be provided to the pixel array 601 as the i+1th source signal SIG_Si+1 and the i+5th source signal SIG_Si+5. Meanwhile, in some embodiments, the source amplifier circuit 655 may not include the n+5th source amplifier SAMPn+5. In an example case in which the source amplifier circuit 655 does not include the n+5th source amplifier SAMPn+5, the display device 600 may provide the n+1th channel signal SIG_CHn+1 as the i+1th source signal SIG_Si+1 and the i+5th source signal SIG_Si+5 to the pixel array 601 while the connection switch SW_CSn+1 is turned on. Accordingly, the green pixels GPX1, GPX3, GPX5 and GPX7 may be controlled by the same source signal.

The connection switch SW_CSn+2 may be connected between the output node of the n+2th source amplifier SAMPn+2 and the output node of the n+6th source amplifier SAMPn+6. The connection switch SW_CSn+2 may be turned on in response to the third switch control signal CS_EN, so that the output of the n+2th source amplifier SAMPn+2 (i.e., the n+2th channel signal SIG_CHn+2) may be provided to one end of the n+6th output switch SW_OUTn+6, or the output of the n+6th source amplifier SAMPn+6 (i.e., the n+6th channel signal SIG_CHn+5) may be provided to one end of the n+2th output switch SW_OUTn+2. That is, the n+2th channel signal SIG_CHn+2 may be provided to the pixel array 601 as the i+2th source signal SIG_Si+2 and the i+6th source signal SIG_Si+6, or the n+6th channel signal SIG_CHn+6 may be provided to the pixel array 601 as the i+2th source signal SIG_Si+2 and the i+6th source signal SIG_Si+6. Meanwhile, in some embodiments, the source amplifier circuit 655 may not include the n+6th source amplifier SAMPn+6. In an example case in which the source amplifier circuit 655 does not include the n+6th source amplifier SAMPn+6, the display device 600 may provide the n+2th channel signal SIG_CHn+2 as the i+2th source signal SIG_Si+2 and the i+6th source signal SIG_Si+6 to the pixel array 601 while the connection switch SW_CSn+2 is turned on. Accordingly, red pixels (e.g., RPX2 and RPX4) and blue pixels (e.g., BPX2 and BPX4) may be controlled by the same source signal.

The connection switch SW_CSn+3 may be connected between the output node of the n+3th source amplifier SAMPn+3 and the output node of the n+7th source amplifier SAMPn+7. The connection switch SW_CSn+3 may be turned on in response to the third switch control signal CS_EN, so that the output of the n+3th source amplifier SAMPn+3 (i.e., the n+3th channel signal SIG_CHn+3) may be provided to one end of the n+7th output switch SW_OUTn+7, or the output of the n+7th source amplifier SAMPn+7 (i.e., the n+7th channel signal SIG_CHn+7) may be provided to one end of the n+3th output switch SW_OUTn+3. That is, the n+3th channel signal SIG_CHn+3 may be provided to the pixel array 601 as the i+3th source signal SIG_Si+3 and the i+7th source signal SIG_Si+7, or the n+7th channel signal SIG_CHn+7 may be provided to the pixel array 601 as the i+3th source signal SIG_Si+3 and the i+7th source signal SIG_Si+7. Meanwhile, in some embodiments, the source amplifier circuit 655 may not include the n+7th source amplifier SAMPn+7. In an example case in which the source amplifier circuit 655 does not include the n+7th source amplifier SAMPn+7, the display device 600 may provide the n+3th channel signal SIG_CHn+3 as the i+3th source signal SIG_Si+3 and the i+7th source signal SIG_Si+7 to the pixel array 601 while the connection switch SW_CSn+3 is turned on. Accordingly, the green pixels GPX2, GPX4, GPX6, and GPX8 may be controlled by the same source signal.

For example, the driving controller (210 in FIG. 2) may control the operation status of the nth source amplifier SAMPn, the n+1th source amplifier SAMPn+1, the n+2th source amplifier SAMPn+2, and the n+3th source amplifier SAMPn+3 based on the activation signal AMPEN, and may control the output path of the output of the nth source amplifier SAMPn, the n+1th source amplifier SAMPn+1, the n+2th source amplifier SAMPn+2, and the n+3th source amplifier SAMPn+3 based on the selection signal SEL.

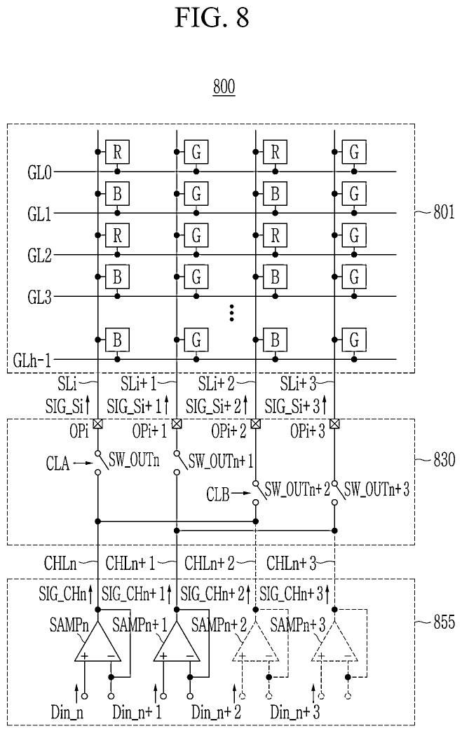

FIG. 8 is a diagram showing parts of a display device according to an embodiment.

A display device 800 may include a pixel array 801, a switching circuit 830, and a source amplifier circuit 855. For example, FIG. 8 is a diagram showing parts of the pixel array 801, the switching circuit 830, and the source amplifier circuit 855.

In some embodiments, the pixel array 801 may have the same or similar description as the pixel array 501 of FIG. 5. In some embodiments, the source amplifier circuit 855 may have the same or similar description as the source amplifier circuit 555 of FIG. 5.

The switching circuit 830 may control the output path of the output signals of the source amplifier circuit 855. The switching circuit 830 may include a plurality of output switches that selectively connect the plurality of channel lines CHL of the source amplifier circuit 855 to the plurality of source lines SL. For example, the switching circuit 830 may include the nth output switch SW_OUTn, the n+1th output switch SW_OUTn+1, the n+2th output switch SW_OUTn+2, and the n+3th output switch SW_OUTn+3.

The output switch SW_OUTq (q is an integer greater than or equal to 0 and less than or equal to m) may be connected between the output node of the corresponding source amplifier SAMPq and the corresponding output pad OPq. Regarding the output switch SW_OUTq, the content described above in FIG. 5 may be applied in the same or similar manner.

In the display device 800 according to FIG. 8, unlike the display device 500 in FIG. 5, the nth channel line CHLn and the n+2th channel line CHLn+2 may be directly connected without a separate connection switch. Additionally, the n+1th channel line CHLn+1 and the n+3th channel line CHLn+3 may be directly connected without a separate connection switch.

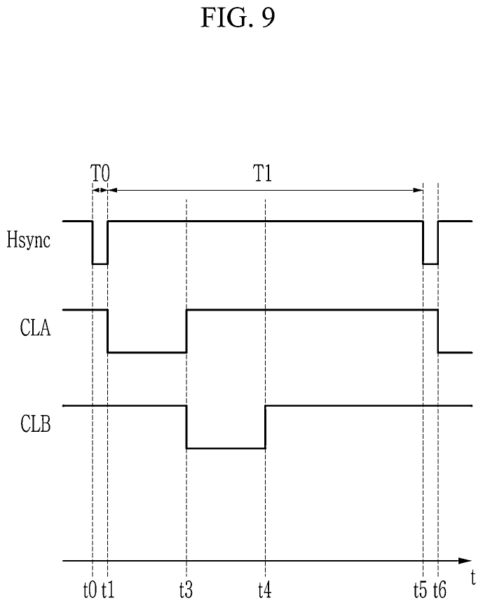

FIG. 9 is a timing diagram showing the operation of the display device according to FIG. 8.

The display device 800 may operate in the first period T0 and the second period T1. The first period T0 may be a period in which image data is not output to the pixel array 501. In the first period T0, the horizontal synchronization signal Hsync may be turned off.

The second period T1 may be an image output period in which image data is output to the pixel array 501. In the second period T1, the horizontal synchronization signal Hsync may be turned on.

The description of the first switch selection signal CLA and the second switch selection signal CLB in the first period T0 and the second period T1 may be applied in the same or similar manner as the description of the first switch selection signal CLA and the second switch selection signal CLB described with reference to FIG. 6.

For example, at t1, the nth output switch SW_OUTn and the n+1th output switch SW_OUTn+1 may be turned on by the first switch selection signal CLA of the enable level. Accordingly, the nth source amplifier SAMPn may output the generated channel signal SIG_CHn as the source signal SIG_Si to the ith source line SLi. Additionally, the n+1th source amplifier SAMPn+1 may output the generated channel signal SIG_CHn+1 as the source signal SIG_Si+1 to the i+1th source line SLi+1.

Meanwhile, unlike the display device 500 of FIG. 5, the nth channel line CHLn and the n+2th channel line CHLn+2, and the n+1th channel line CHLn+1 and the n+3th channel line CHLn+3 may be connected directly without a separate connection switch. Accordingly, the display device 800 may operate without the third switch control signal CS_EN. For example, in a case in which the second switch selection signal CLB is at the enable level, the channel signal SIG_CHn may be output as the source signal SIG_Si+2 to the i+2th source line SLi+2, and the channel signal SIG_CHn+1 may be output as the source signal SIG_Si+3 to the i+3th source line SLi+3.

At t3, the n+2th output switch SW_OUTn+2 and the n+3th output switch SW_OUTn+3 may be turned on by the second switch selection signal CLB of the enable level. At the same time, the nth output switch SW_OUTn and the n+1th output switch SW_OUTn+1 may be turned off by the first switch selection signal CLA of the disable level. Accordingly, the n+2th source amplifier SAMPn+2 may output the generated channel signal SIG_CHn+2 as the source signal SIG_Si+2 to the i+2th source line SLi+2, and the n+3th source amplifier SAMPn+3 may output the generated channel signal SIG_CHn+3 as the source signal SIG_Si+3 to the i+3th source line SLi+3.

Meanwhile, unlike the display device 500 of FIG. 5, the nth channel line CHLn and the n+2th channel line CHLn+2, and the n+1th channel line CHLn+1 and the n+3th channel line CHLn+3 may be connected directly without a separate connection switch. Accordingly, the display device 800 may operate without the third switch control signal CS_EN. For example, in a case in which the second switch selection signal CLA is at the enable level, the channel signal SIG_CHn+2 may be output as the source signal SIG_Si+2 to the ith source line SLi, and the channel signal SIG_CHn+3 may be output as the source signal SIG_Si+1 to the i+1th source line SLi+1.

Referring to FIG. 9, the display device 800 may repeatedly perform the first period T0 and the second period T1.

Meanwhile, the order in which the first switch selection signal CLA and the second switch selection signal CLB are generated is not limited thereto.

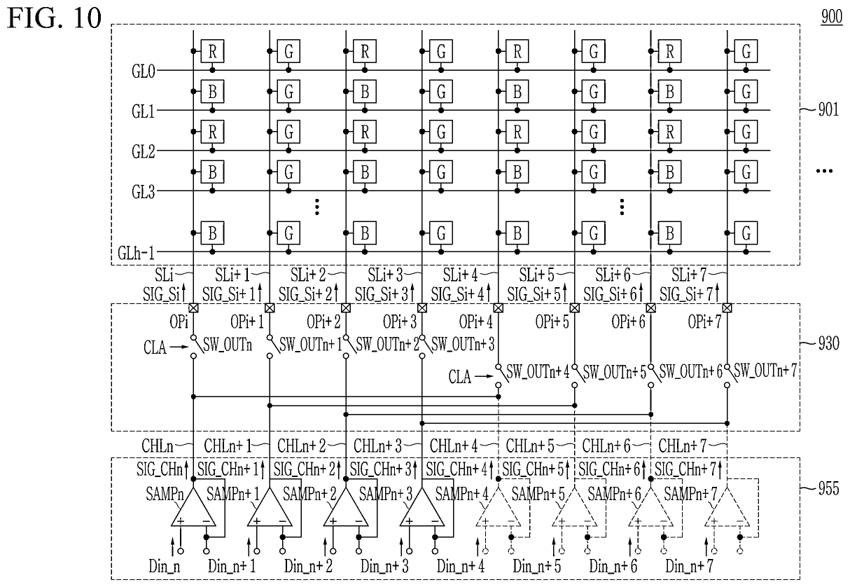

FIG. 10 is a diagram showing parts of a display device according to an embodiment.

A display device 900 may include a pixel array 901, a switching circuit 930, and a source amplifier circuit 955. For example, FIG. 10 is a diagram showing parts of the pixel array 901, the switching circuit 930, and the source amplifier circuit 955.

In some embodiments, the pixel array 901 may have the same or similar description as the pixel array 601 of FIG. 7. In some embodiments, the source amplifier circuit 955 may have the same or similar description as the source amplifier circuit 655 of FIG. 7.

The switching circuit 930 may control the output path of the output signals of the source amplifier circuit 955. The switching circuit 930 may include a plurality of output switches that selectively connect the plurality of channel lines CHL of the source amplifier circuit 955 to the plurality of source lines SL. For example, the switching circuit 930 may include the nth output switch SW_OUTn, the n+1th output switch SW_OUTn+1, the n+2th output switch SW_OUTn+2, and the n+3th output switch SW_OUTn+3.

The output switch SW_OUTq (q is an integer greater than or equal to 0 and less than or equal to m) may be connected between the output node of the corresponding source amplifier SAMPq and the corresponding output pad OPq. Regarding the output switch SW_OUTq, the content described above in FIG. 7 may be applied in the same or similar manner.

In the display device 900 according to FIG. 10, unlike the display device 600 in FIG. 7, the nth channel line CHLn and the n+4th channel line CHLn+4 may be directly connected without a separate connection switch. Additionally, the n+1th channel line CHLn+1 and the n+5th channel line CHLn+5 may be directly connected without a separate connection switch. The n+2th channel line CHLn+2 and the n+6th channel line CHLn+6 may be directly connected without a separate connection switch. The n+3th channel line CHLn+3 and the n+7th channel line CHLn+7 may be directly connected without a separate connection switch.

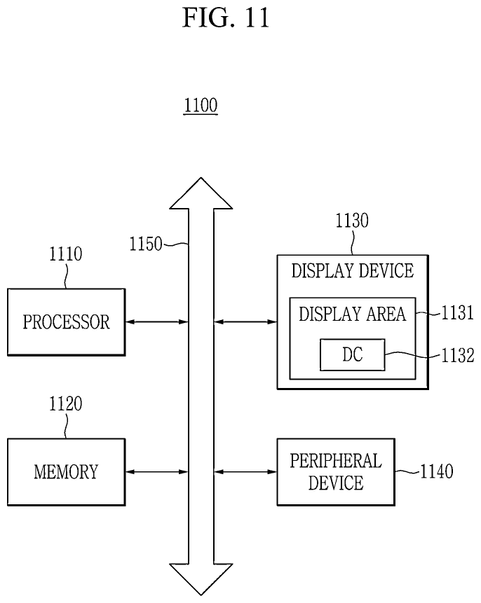

FIG. 11 is a diagram showing a display system according to an embodiment.

Referring to FIG. 11, according to an embodiment, a display system 1100 may include a processor 1110, a memory 1120, a display device 1130, a peripheral device 1140, and a system bus 1150. However, the disclosure is not limited thereto, and as such, according to an embodiment, the display system 1100 may include other electronic components, electronic elements and/or electronic devices. According to an embodiment, the processor 1110, memory 1120, the display device 1130, and the peripheral device 1140 may be electrically connected to each other through the system bus 1150.

The processor 1110 may control one or more operations of display system 1100. For example, the processor 1110 may control input and/or output of data from the memory 1120, the display device 1130, and the peripheral device 1140. Moreover, the processor 1110 may perform image processing of image data transmitted between various devices. For example, the processor 1110 may perform image processing of image data transmitted between the memory 1120 and the display device 1130, between the memory 1120 and the peripheral device 1140, and between the peripheral device 1140 and the display device 1130.

Memory 1120 may include volatile memory such as dynamic random-access memory (DRAM) and/or non-volatile memory such as flash memory. The memory 1120 may include, but is not limited to, DRAM, phase-change random access memory (PRAM), magnetic random access memory (MRAM), resistive random access memory (ReRAM), ferroelectric random access memory (FRAM), NOR flash memory, NAND flash memory, and fusion flash memory. For example, the fusion flash memory maybe memory combined with static random access memory (SRAM) buffer and NAND flash memory and NOR interface logic. The memory 1120 may store image data obtained from the peripheral device 1140 or image signals processed by the processor 1110.

The display device 1130 includes a display panel 1131 and may display image data transmitted through the system bus 1150 on the display panel 1131. The display panel 1131 may be a panel having an RGBG pixel arrangement structure. The display device 1130 may include a driving circuit (DC) 1132. The driving circuit 1132 may include a plurality of first source lines connected to a plurality of blue pixels and a plurality of red pixels in the display panel 1131, and a plurality of second source lines connected to a plurality of green pixels. In some embodiments, two first source lines among the plurality of first source lines may be connected to each other. For example, two adjacent first source lines among the plurality of first source lines may be connected to each other. In some embodiments, two second source lines among the plurality of second source lines may be connected to each other. For example, two adjacent second source lines among the plurality of second source lines may be connected to each other. The driving circuit 1132 may include a plurality of first source amplifiers connected to the plurality of first source lines and a plurality of second source amplifiers connected to the plurality of second source lines. The plurality of first source amplifiers may generate first source signals for driving the blue pixel and the red pixel. The plurality of second source amplifiers may generate second source signals for driving the green pixel.

The display device 1130 may drive a plurality of green pixels using a second source signal. Since the green pixel is driven by the second source signal, the voltage of the second source signal does not change, and the display device 1130 may output green color while consuming less power.

The peripheral device 1140 may be a device that converts motion pictures or still images into electrical signals. For example, the peripheral device 1140 may include, but is not limited to, a camera, scanner or webcam. Image data obtained through the peripheral device 1140 may be stored in the memory 1120 or displayed on the display panel 1131 in real time. For example, the processor 1110 may process the image data obtained through the peripheral device 1140 and store the processed image data in the memory 1120. In another example, the processor 1110 may process the image data obtained through the peripheral device 1140 and display the processed image data on the display panel 1131 in real time.

The display system 1100 may be installed in mobile electronic products such as smartphones, but is not limited thereto, and may be installed in various types of electronic products that display images.

While the embodiments of the disclosure have been described in detail, it is to be understood that the disclosure is not limited to the disclosed embodiments, but on the contrary, is intended to cover various modifications and equivalent arrangements included within the spirit and scope of the appended claims.

In some embodiments, each constituent element or combination of two or more constituent elements described with reference to FIGS. 1 to 11 may be implemented by a digital circuit, a programmable or non-programmable logic device or array, or an application specific integrated circuit (ASIC), and the like.

While the embodiments of the disclosure have been described in detail, it is to be understood that the disclosure is not limited to the disclosed embodiments, but on the contrary, is intended to cover various modifications and equivalent arrangements included within the spirit and scope of the appended claims.

What is claimed is:

1. A display driving device, comprising:
a plurality of first source amplifiers configured to generate a first channel signal corresponding to a first pixel of a first color and a second channel signal corresponding to a second pixel of a second color;
a plurality of second source amplifiers configured to generate a third channel signal corresponding to a third pixel of a third color;
a plurality of first output pads configured to output the first channel signal and the second channel signal;
a plurality of second output pads configured to output the third channel signal;
a plurality of first channel lines connected between the plurality of first output pads and the plurality of first source amplifiers; and
a plurality of second channel lines connected between the plurality of second output pads and the plurality of second source amplifiers,
wherein a first first channel line and a second first channel line among the plurality of first channel lines are connected to each other, and a first second channel line and a second second channel line among the plurality of second channel lines are connected to each other.

2. The display driving device of claim 1, further comprising:
a first connection switch provided between the first first channel line and the second first channel line, which are adjacent among the plurality of first channel lines, and
a second connection switch provided between the first second channel line and the second second channel line, which are adjacent among the plurality of second channel lines.

3. The display driving device of claim 2, further comprising:
a first output switch provided between one of the plurality of first channel lines and one of a plurality of first source lines, and a second output switch provided between one of the plurality of second channel lines and one of a plurality of second source lines.

4. The display driving device of claim 3, further comprising:
a driving controller configured to:
control the first output switch by a first switch selection signal,
control the second output switch by a second switch selection signal, and
control the first and second connection switches by a third switch selection signal.

5. The display driving device of claim 4, wherein
the driving controller is further configured to generate the first switch selection signal and the second switch selection signal to alternately have an enable level during an image output period, and generate the third switch selection signal has an enable level during the image output period.

6. The display driving device of claim 1, further comprises:
among the plurality of first channel lines, a 2k−1th first channel line is one of third channel lines, the 2kth first channel line is one of fourth channel lines, two of the third channel lines adjacent to each other are connected to each other, and two of the fourth channel lines adjacent to each other are connected to each other, k being an integer equal to or greater than 1, and
among the plurality of second channel lines, a 2k−1th second channel line is one of fifth channel lines, the 2kth second channel line is one of sixth channel lines, two of the fifth channel lines adjacent to each other are connected to each other, and two of the sixth channel lines adjacent to each other are connected to each other.

7. The display driving device of claim 6, further comprising:
a first output switch provided between one of the plurality of first channel lines and one of the plurality of first source lines; and
a second output switch provided between one of the plurality of second channel lines and one of the plurality of second source lines.

8. The display driving device of claim 7, further comprising: a driving controller configured to generate a first switch control signal to control the first output switch and the second output switch connected to a channel line having a same k value among the third channel lines, the fourth channel lines, the fifth channel lines, and the sixth channel lines.

9. The display driving device of claim 6, further comprising:
a plurality of first connection switches, each provided between the two adjacent third channel lines, between the two adjacent fourth channel lines, between the two adjacent fifth channel lines, and between the two adjacent sixth channel lines.

10. The display driving device of claim 9, further comprising:
a driving controller configured to generate a third switch selection signal to control the plurality of first connection switches,
wherein, during an image output period, the third switch selection signal has an enable level.

11. The display driving device of claim 1, wherein
the first color is blue, the second color is red, and the third color is green.

12. The display driving device of claim 1, wherein
two adjacent first channel lines among the plurality of first channel lines are connected to each other, and two adjacent second channel lines among the plurality of second channel lines are connected to each other.

13. A display device, comprising:
a pixel array comprising:
a plurality of first pixels of a first color, a plurality of second pixels of a second color, and a plurality of third pixels of a third color, the plurality of first pixels of the first color and the plurality of third pixels of the third color are repeatedly provided on odd-numbered pixel rows and connected to one of a plurality of first source lines, and the plurality of second pixels of the second color and the plurality of third pixels of the third color are repeatedly provided on even-numbered pixel rows and connected to one of a plurality of second source lines; and
a switching circuit comprising:
a first connection switch provided between a plurality of first channel lines connected to corresponding first source line among the plurality of first source lines,
a second connection switch provided between a plurality of second channel lines connected to corresponding second source line among the plurality of second source lines,
a third connection switch between two first channel lines among the plurality of first channel lines, and
a fourth connection switch between two second channel lines among the plurality of second channel lines.

14. The display device of claim 13, further comprising:
a first output switch provided between one of the plurality of first channel lines and the plurality of first source lines; and
a second output switch provided between one of the plurality of second channel lines and the plurality of second source lines.

15. The display device of claim 14, wherein
a driving controller configured to:
the first output switch is controlled by a first switch selection signal, the second output switch is controlled by a second switch selection signal, and during the image output period, the first switch selection signal and the second switch selection signal alternately have enable levels.

16. The display device of claim 13, wherein
among the plurality of first channel lines, a 2k−1th first channel line is one of third channel lines, the 2kth first channel line is one of fourth channel lines, two of the third channel lines adjacent to each other are connected to each other, and two of the fourth channel lines adjacent to each other are connected to each other, k being an integer equal to or greater than 1, and
among the plurality of second channel lines, a 2k−1th second channel line is one of fifth channel lines, the 2kth second channel line is one of sixth channel lines, two of the fifth channel lines adjacent to each other are connected to each other, and two of the sixth channel lines adjacent to each other are connected to each other.

17. The display device of claim 16, further comprising:
a first output switch provided between one of the plurality of first channel lines and the plurality of first source lines; and
a second output switch provided between one of the plurality of second channel lines and one of the plurality of second source lines.

18. The display device of claim 17, further comprising: a driving controller configured to generate a first switch control signal to control the first output switch and the second output switch connected to a channel line having a same k value among the third channel lines, the fourth channel lines, the fifth channel lines, and the sixth channel lines.

19. A display device, comprising:
a pixel array comprising a plurality of first pixels of a first color, a plurality of second pixels of a second color, and a plurality of third pixels of a third color, the plurality of first pixels of the first color and the plurality of third pixels of the third color repeatedly provided in odd-numbered pixel rows, and the plurality of second pixels of the second color and the plurality of third pixels of the third color repeatedly provided in even-numbered pixel rows;
a plurality of first source amplifiers connected to each of a plurality of first source lines to drive the plurality of first pixels and the plurality of second pixels; and
a plurality of second source amplifiers connected to each of a plurality of second source lines to drive the plurality of third pixels,
wherein each of the plurality of first source lines and each of the plurality of second source lines are alternately provided, and two adjacent second source lines among the plurality of second source lines are connected to a corresponding second source amplifier among the plurality of second source amplifiers.

20. The display device of claim 19, wherein
two adjacent first source lines among the plurality of first source lines are connected to a corresponding first source amplifier among the plurality of first source amplifiers.
